(19) United States
(12) Patent Application Publication
(10) Pub. No.: US 2011/0275765 A1
(43) Pub. Date: Nov. 10, 2011

(54) PROCESS FOR PRODUCING ETHYLENE-PROPYLENE COPOLYMER

(75) Inventors: Yasuki FUJIWARA, Ichikawa-shi (JP); Makoto SATOH, Chiba-Shi (JP); Shinya NAKAHARA, Ichihara-shi (JP); Shin-ichi KUMAMOTO, Ichihara-shi (JP)

(73) Assignee: SUMITOMO CHEMICAL COMPANY, LIMITED, Tokyo (JP)

(21) Appl. No.: 13/162,998

(22) Filed: Jun. 17, 2011

Related U.S. Application Data
(62) Division of application No. 12/514,240, filed on May 28, 2009, now abandoned.

(30) Foreign Application Priority Data
Dec. 15, 2006 (JP) 2006-338998
Dec. 15, 2006 (JP) 2006-338999

(51) Int. Cl. C08L 23/16; C08F 4/649

(52) U.S. Cl. 525/240; 526/125.6

(57) ABSTRACT

There are provided an ethylene-propylene copolymer having the following structural characteristics, and a polypropylene resin composition comprising the above copolymer and polypropylene having a melting temperature of 160° C. or higher:
(1) its propylene content is 20 to 60% by mol;
(2) its product of a monomer reactivity ratio is less than 2.5;
(3) its intrinsic viscosity is more than 1.0 dl/g;
(4) its molecular weight distribution is more than 3;
(5) its glass transition temperature is lower than −40° C.;
(6) its heat of crystallization is less than 5.0 J/g;
(7) in a temperature rising elution fractionation method, its elution amount is 60% by weight or more in a temperature range of lower than 10° C., its elution amount is 3% by weight or more in a temperature range of 10° C. to lower than 55° C., and its elution amount is 5% by weight or less in a temperature range of 83° C. or higher, provided that the total elution amount is 100% by weight; and
(8) an intensity ratio of a racemic peak to a meso peak in an ethylene-propylene binding moiety in a ¹³C-NMR spectrum is 0.01 to 0.7.

### CROSS-REFERENCE TO RELATED APPLICATIONS

This application is a Divisional of U.S. patent application Ser. No. 12/514,240, filed May 28, 2009, which was a Section 371 of International Application No. PCT/JP2007/074598, filed Dec. 14, 2007, which was published in the Japanese language on Jun. 19, 2008 under International Publication No. WO 2008/072789 A1, and the disclosures of which are incorporated herein by reference.

### BACKGROUND OF THE INVENTION

The present invention relates to a polypropylene resin composition excellent in its stiffness and impact resistance, and relates to an ethylene-propylene copolymer useful as a component for the above polypropylene resin composition.

Molded articles comprising polypropylene are used for various applications because of their excellent stiffness, heat resistance and surface gloss.

As a polypropylene resin material excellent in its impact resistance, there is known a polypropylene resin composition comprising a polypropylene and an ethylene-propylene copolymer.

For example, JP 5-178945A discloses a polypropylene resin composition comprising an ethylene-propylene copolymer, in which copolymer a product of a monomer reactivity ratio has a specific value.

JP 9-151282A discloses a polypropylene resin composition comprising a polypropylene and an ethylene-propylene copolymer rubber, and having a specific calorific value of crystallization measured with a differential scanning calorimeter.

JP 1-287110A discloses an amorphous propylene-ethylene copolymer specified by its infrared absorption spectrum and ¹³C-NMR spectrum.

JP 4-261413A discloses a propylene-ethylene copolymer specified by its melt flow rate and ¹³C-NMR spectrum.

However, the above conventional polypropylene resin materials also are not necessarily sufficient in their stiffness and impact resistance of a polypropylene resin composition thereof.

### BRIEF SUMMARY OF THE INVENTION

An object of the present invention is to provide a polypropylene resin material excellent in its stiffness and impact resistance

Firstly, the present invention provides an ethylene-propylene copolymer having the following structural characteristics (1) to (8):

(1) its propylene content measured according to a ¹³C-NMR spectrum is 20 to 60% by mol;

(2) its product of a monomer reactivity ratio measured according to a ¹³C-NMR spectrum is less than 2.5;

(3) its intrinsic viscosity measured at 135° C. in TETRALINE is more than 1.0 dl/g;

(4) its molecular weight distribution measured according to gel permeation chromatography is more than 3;

(5) its glass transition temperature measured according to DSC is lower than −40° C.;

(6) its heat of crystallization in a temperature range of 40 to 110° C. measured according to DSC is less than 5.0 J/g;

(7) in a temperature rising elution fractionation method with a solvent of o-dichlorobenzene, its elution amount is 60% by weight or more in a temperature range of lower than 10° C., its elution amount is 3% by weight or more in a temperature range of 10° C. to lower than 55° C., and its elution amount is 5% by weight or less in a temperature range of 83° C. or higher, provided that the total elution amount is 100% by weight; and

(8) an intensity ratio of a racemic peak to a meso peak in an ethylene-propylene binding moiety measured according to a ¹³C-NMR spectrum is 0.01 to 0.7.

Secondly, the present invention provides a polypropylene resin composition, which comprises 55 to 95% by weight of polypropylene having a melting temperature of 160° C. or higher measured according to DSC, and 5 to 45% by weight of the above ethylene-propylene copolymer, the total of the polypropylene and the ethylene-propylene copolymer being 100% by weight.

### DETAILED DESCRIPTION OF THE INVENTION

The polypropylene contained in the polypropylene resin composition of the present invention is a propylene homopolymer or a propylene copolymer obtained by copolymerizing propylene with one or more kinds of olefins selected from the group consisting of ethylene and α-olefins having 4 to 18 carbon atoms, the polypropylene having a melting temperature of 160° C. or higher, and preferably 160 to 170° C. measured according to differential scanning calorimetry (hereinafter, referred to as DSC). The above propylene copolymer may be a random copolymer or a block copolymer.

The above propylene copolymer contains one or more kinds of olefins selected from the group consisting of ethylene and a-olefins having 4 to 18 carbon atoms, in an amount of preferably 10% by mol or less, provided that the total of the monomer units in the above propylene copolymer is 100% by mol.

Examples of the above α-olefin having 4 to 18 carbon atoms are 1-butene, 1-pentene, 1-hexene, 1-heptene, 1-octene, 4-methyl-1-pentene, vinylcyclohexane and vinylnorbornene.

The polypropylene contained in the polypropylene resin composition of the present invention has a melt flow rate (hereinafter, referred to as MFR) of 0.1 to 500 g/10 minutes, and preferably 0.3 to 300 g/10 minutes, measured at 230° C. under a load of 21 N according to JIS K7210.

The polypropylene contained in the polypropylene resin composition of the present invention can be produced according to various polymerization methods, using a usual stereoregular catalyst.

The stereoregular catalyst applicable to the present invention is, for example, a catalyst comprising a solid titanium catalyst component, an organometallic compound catalyst component, and an optional electron donor.

The ethylene-propylene copolymer of the present invention contained in the polypropylene resin composition of the present invention is obtained by copolymerizing ethylene with propylene, and contains structural units derived from ethylene and structural units derived from propylene.

The ethylene-propylene copolymer (B) contained in the polypropylene resin composition of the present invention contains 20 to 60% by mol, and preferably 30 to 50% by mol of propylene, measured according to a ¹³C nuclear magnetic resonance (¹³C-NMR) spectrum. When the propylene content is less than 20% by mol, the composition containing such an ethylene-propylene copolymer may be insufficient in its impact strength, due to its insufficient compatibility with polypropylene, and due to formation of a polyethylene crystal component in the ethylene-propylene copolymer. When the propylene content is more than 60% by mol, the composition containing such an ethylene-propylene copolymer may be insufficient in its stiffness, due to its too much compatibility with polypropylene.

The ethylene-propylene copolymer of the present invention has a high random nature, and its product (r1r2) of a monomer reactivity ratio measured according to a ¹³C-NMR spectrum is less than 2.5, preferably less than 2.0, and more preferably less than 1.8. When the product of a monomer reactivity ratio is more than 2.5, the composition of the present invention may be insufficient in its stiffness and impact strength, due to too much amount of a component compatible with the polypropylene, and due to too much amount of a polyethylene crystal component. A degree of irregularity of polymerization in a copolymer or a copolymer portion of a polymer, and a standard method for indicating the degree are discussed in “Textbook of Polymer Chemistry”, F. W. Billmeyer, Jr., Interscience Publishers, New York, 1957, pages 221 or later. A degree of a polymerization procedure is determined by reactivity of respective monomers to an end of a polymer chain. When a propagating polymer chain reacts strongly selectively with another monomer, an alternate structure is observed. When a propagating polymer chain reacts equally selectively with one monomer and with another monomer, an irregular copolymerization occurs, and therefore, those two kinds of monomers are observed irregularly along a polymer chain in a relative amount determined by an olefin composition fed. When a propagating polymer chain reacts strongly selectively with the same monomer as that existing at the end of the propagating polymer chain, a block copolymer is formed. Regarding the term “monomer reactivity ratio”, the Billmeyer textbook mentions that the monomer reactivity ratios r1 and r2 are the ratios of the rate constant for a given radical adding its own monomer to that for its adding the other monomer. A magnitude of this numerical value related to a tendency of a reaction with the same monomer as that existing at the end of a propagating polymer chain. When a numerical value of r1 is larger than 1, a propagating polymer chain having the first monomer (M₁) at its end, the propagating polymer chain reacts selectively with the first monomer (M₁). When a numerical value of r1 is smaller than 1, a propagating polymer chain having the first monomer (M₁) at its end, the propagating polymer chain reacts selectively with the second monomer (M₂). A similar consideration is applied to a numerical value of r2. The above consideration is generally applied to copolymerization deriving the ethylene-propylene copolymer of the present invention. The above reference literature further discloses copolymerization regarding a product of a monomer reactivity ratio, namely r1r2. It is a necessary condition for r1r2 to have a numerical value of 0 (zero) to form an alternate copolymer. When r1r2 has a numerical value of 1, the completely irregular copolymer is obtained. When r1r2 has a numerical value of larger than 1, at least a slightly block-like copolymer is obtained. The larger the numerical value of r1t2 is, the more block-like copolymer is obtained. The above reference literature discloses a mathematical deviation of the numerical value of r1t2.

As the Billmeyer reference discloses a correlation of a feed composition, an r1t2 value for a specified copolymer is determined conventionally by measuring experimentally a copolymer composition. Other more direct method is based on a nuclear magnetic resonance (NMR) spectrum, particularly a ¹³C-NMR spectrum of a copolymer, which is disclosed in Kakugo, et al., Macromolecules, 15, 1150 (1982). The present invention adopts a method of determination by a ¹³C-NMR spectrum.

The ethylene-propylene copolymer of the present invention has an intrinsic viscosity of larger than 1.0 dl/g, preferably larger than 1.5 dl/g, and particularly preferably larger than 2.0 dl/g, measured at 135° C. in TETRALINE (tetrahydronaphthalene). When the [η] is smaller than 1.0 dl/g, a resin composition comprising polypropylene and the copolymer may not be sufficient in its impact strength.

The ethylene-propylene copolymer of the present invention has a ratio of a weight average-molecular chain length (Aw) to a number average-molecular chain length (An), Aw/An, of preferably larger than 3, and particularly preferably larger than 5, measured according to gel permeation chromatography (hereinafter, referred to as GPC), from a viewpoint of reducing a low molecular weight component, and improving a resin composition with polypropylene in its impact strength and processability. Incidentally, the ratio Aw/An is equal to a ratio of a weight average molecular weight (Mw) to a number average molecular weight (Mn), Mw/Mn, measured according to GPC. The ratio Mw/Mn is generally referred to as a “molecular weight distribution”, and therefore, the ratio Aw/An also means a molecular weight distribution.

The ethylene-propylene copolymer of the present invention has a glass transition temperature (hereinafter, referred to as Tg) of lower than −40° C., and preferably lower than −50° C., measured according to DSC. The ethylene-propylene copolymer of the present invention has heat of crystallization in a temperature range of 40 to 110° C. of smaller than 5.0 J/g, and preferably 2.0 J/g, measured according to DSC. When Tg is higher than −40° C., or the heat of crystallization in a temperature range of 40 to 110° C. is larger than 5.0 J/g, impact strength may be insufficient. In a temperature rising elution fractionation method with a solvent of o-dichlorobenzene, the ethylene-propylene copolymer of the present invention has an elution amount of 60% by weight or more, and preferably 65% by weight or more in a temperature range of lower than 10° C., has an elution amount of 3% by weight or more, preferably 5% by weight or more in a temperature range of 10° C. to lower than 55° C., and has an elution amount of 5% by weight or less, and preferably 4% by weight or less in a temperature range of 83° C. or higher, provided that the total elution amount is 100% by weight.

When the elution amount is less than 60% by weight in a temperature range of lower than 10° C., is less than 3% by weight in a temperature range of 10° C. to lower than 55° C., or is more than 5% by weight in a temperature range of 83° C. or higher, the total elution amount being 100% by weight, impact strength may be insufficient.

The ethylene-propylene copolymer of the present invention has an intensity ratio of a racemic peak to a meso peak in its ethylene-propylene binding moiety is 0.01 to 0.7, preferably 0.03 to 0.6, and more preferably 0.05 to 0.5, measured according to a ¹³C-NMR spectrum. The meso peak and racemic peak in an ethylene-propylene binding moiety are assigned in a literature such as Macromolecules, 1984, 17, page 1950 and Journal of Applied Polymer Science, 1995, 56, page 1782, and a meso peak is two peaks observed at about 37.5 ppm and about 37.9 ppm, respectively, and a recemic peak is two peaks observed at about 38.4 ppm and about 38.8 ppm, respectively. The total of peak strength of two peaks observed at about 37.5 ppm and about 37.9 ppm is a meso peak strength, and the total of peak strength of two peaks observed at about 38.4 ppm and about 38.8 ppm is a racemic peak strength. When the intensity ratio of a racemic peak to a meso peak is smaller than 0.01, or larger than 0.7, low temperature impact resistance may not be sufficient.

The ethylene-propylene copolymer of the present invention can be produced according to a polymerization method known in the art, by contacting a Ti—Mg solid catalyst component disclosed in JP 11-322833A with an organoaluminum compound in an amount of 10 to 300 mol per 1 mol of a titanium atom contained in the above Ti—Mg solid catalyst component.

The Ti—Mg solid catalyst component contains a titanium atom, a magnesium atom, a halogen atom and an electron donor, and this catalyst component enables satisfaction of the above requirement (4).

The above Ti—Mg solid catalyst component contains an electron donor in an amount of preferably 10 to 50% by weight, more preferably 15 to 50% by weight, further preferably 20 to 40% by weight, and particularly preferably 22 to 35% by weight, the total weight of the dried Ti—Mg solid catalyst component being 100% by weight. When the amount is more than 50% by weight, polymerization activity may be poor, and when the amount is less than 15% by weight, the above requirements (2), (5), (6), (7) and (8) may not be satisfied.

Examples of the electron donor used for the solid catalyst component are oxygen-containing electron donors such as ethers, ketones, aldehydes, carboxylic acids, organic acid esters, inorganic acid esters, organic acid amides, inorganic acid amides and acid anhydrides; and nitrogen-containing electron donors such as ammonias, amines, nitriles and isocyanates. Among them, preferred are organic acid esters and/or ethers, more preferred are carboxylic acid esters and/or ethers, and further preferred are carboxylic acid esters.

Among the carboxylic acid esters, preferably used are unsaturated aliphatic carboxylic acid esters such as methacrylic acid esters and maleic acid esters, or aromatic carboxylic acid esters such as benzoic acid esters and phthalic acid esters. Among them, more preferred are aromatic polycarboxylic acid esters, and further preferred are dialkyl phthalates.

The above solid catalyst component contains a titanium atom in an amount of preferably 0.6 to 2.5% by weight, more preferably 0.6 to 2.0% by weight, further preferably 0.6 to 1.6% by weight, and particularly preferably 0.8 to 1.4% by weight, the total weight of the dried solid catalyst component being 100% by weight. When the amount is less than 0.6% by weight, polymerization activity may be poor, and when the amount is more than 2.5% by weight, the above requirements (2), (5), (6), (7) and (8) may not be satisfied.

The above solid catalyst component is preferably produced according to a process comprising the step of contacting a solid component containing a magnesium atom, a titanium atom and a hydrocarbyloxy group, a halogenation compound and a ester compound with one another, and preferably the step of contacting a solid component (a) containing a magnesium atom, a titanium atom and a hydrocarbyloxy group, a halogenation compound (b) and a phthalic acid derivative (c) with one another, which is explained below in more detail.

(a) Solid Component

The solid component (a) can be obtained by reducing a titanium compound (ii) represented by the following formula [I] with an organomagnesium compound (iii) in the presence of an organosilicon compound (i) containing a Si—O bond, wherein coexistence of an ester compound as an optional component may further improve a polymerization activity:

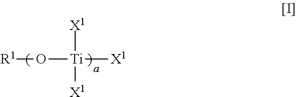

wherein R¹ is a hydrocarbyl group having 1 to 20 carbon atoms; X¹ is independently of one another a halogen atom or a hydrocarbyloxy group having 1 to 20 carbon atoms; and a is a number of 1 to 20.

The organosilicon compound (i) containing a Si—O bond is preferably an alkoxysilane compound represented by the formula, Si(OR²)ₜR³₄₋ₜ, wherein R² is a hydrocarbyl group having 1 to 20 carbon atoms; R³ is a hydrocarbyl group having 1 to 20 carbon atoms or a hydrogen atom; and t is preferably a number satisfying 1≦t≦4, particularly preferably a tetraalkoxysilane having t of 4, and most preferably tetraethoxysilane.

The titanium compound (ii) is represented by the following formula [I]:

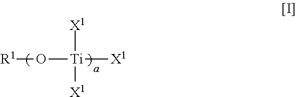

wherein R¹ is a hydrocarbyl group having 1 to 20 carbon atoms; X¹ is independently of one another a halogen atom or a hydrocarbyloxy group having 1 to 20 carbon atoms; and a is a number of 1 to 20.

The titanium compound (ii) is preferably tetra-n-butoxytitanium, tetra-n-butyltitanium dimer, or tetra-n-butyltitanium tetramer.

The organomagnesium compound (iii) is any type of organomagnesium compounds having a magnesium-carbon bond. Particularly preferably used are Grignard compounds represented by the formula, R⁴MgX², wherein Mg is a magnesium atom, R⁴ is a hydrocarbyl group having 1 to 20 carbon atoms, and X² is a halogen atom, or are dihydrocarbylmagnesium represented by the formula, R⁵R⁶Mg, wherein Mg is a magnesium atom, and each of R⁵ and R⁶ is a hydrocarbyl group having 1 to 20 carbon atoms, and R⁵ and R⁶ are the same as, or different from each other. Examples of R⁵ and R⁶ are independently each other alkyl groups having 1 to 20 carbon atoms, aryl groups, aralkyl groups and alkenyl groups, such as a methyl group, an ethyl group, a propyl group, an isopropyl group, a butyl group, a sec-butyl group, a tert-butyl group, an isoamyl group, a hexyl group, an octyl group, a 2-ethylhexyl group, a phenyl group and a benzyl group. Particularly preferably used is an ether solution of Grignard compounds represented by the formula, R⁴MgX², from a viewpoint of polymerization activity.

The solid component (a) can be obtained by reducing a titanium compound (ii) with an organomagnesium compound (iii) in the presence of an organosilicon compound (i), or in the presence of an organosilicon compound (i) and an ester compound. Specifically, preferred is a method of adding the organomagnesium compound (iii) to a mixture containing the organosilicon compound (i), the titanium compound (ii) and the optional ester compound.

The reduction reaction is carried out at usually −50 to 70° C., preferably −30 to 50° C., and particularly preferably −25 to 35° C.

The organomagnesium compound (iii) is not limited in its addition time, and usually over about 30 minutes to about 10 hours. Addition of the organomagnesium compound (iii) promotes a reduction reaction, and after completion of the addition thereof, the reaction may be further continued at 20 to 120° C.

The organosilicon compound (i) is used in an amount of usually 1 to 500, preferably 1.5 to 300, and particularly preferably 3 to 100, in terms of a ratio, Si/Ti, wherein Si means a molar amount of a silicon atom contained in the organosilicon compound (i) used, and Ti means a molar amount of a titanium atom contained in the titanium compound (ii) used.

Further, the organomagnesium compound (iii) is used in an amount of usually 0.1 to 10, preferably 0.2 to 5.0, and particularly preferably 0.5 to 2.0, in terms of a ratio, (Ti+Si)/Mg, wherein (Ti+Si) means the total molar amount of a titanium atom contained in the titanium compound (ii) and a silicon atom contained in the organosilicon compound (i) used, and Mg means a molar amount of a magnesium atom contained in the organomagnesium compound (iii) used.

Also, each of the titanium compound (ii), the organosilicon compound (i) and the organomagnesium compound (iii) is determined in its amount used such that the solid catalyst component has a molar ratio of Mg/Ti of usually 1 to 51, preferably 2 to 31, and particularly preferably 4 to 26.

Also, the ester compound (iv) as an optional component is used in an amount of usually 0.05 to 100, preferably 0.1 to 60, and particularly preferably 0.2 to 30, in terms of a ratio, (ester compound)/Ti, wherein (ester compound) means a molar amount of the ester compound (iv) used, and Ti means a molar amount of a titanium atom contained in the titanium compound (ii) used.

The solid component obtained by the reduction reaction is usually subjected to a solid-liquid separation, and then, is washed several times with an inert hydrocarbon solvent such as hexane, heptane and toluene.

So-obtained solid component (a) contains trivalent titanium atoms, magnesium atoms and hydrocarbyloxy groups, and is generally amorphous or very weak crystalline. From a viewpoint of polymerization activity, an amorphous structure is particularly preferable.

(b) Halogenation Compound

The halogenation compound is preferably compounds capable of replacing a hydrocarbyloxy group contained in the solid component (a) with a halogen atom, more preferably halogen compounds of the group 4, 13 or 14 in the periodic table, and further preferably halogen compounds (b1) of the group 4 or halogen compounds (b2) of the group 14.

The halogen compounds (b1) of the group 4 are preferably those represented by the formula, M¹(OR⁹)_{b}X⁴_{4-b}, wherein M¹ is an atom of the group 4; R⁹ is a hydrocarbyl group having 1 to 20 carbon atoms; X⁴ is a halogen atom; and b is a number satisfying 0≦b≦4. Examples thereof are titanium tetrahalides such as titanium tetrachloride, titanium tetrabromide and titanium tetraiodide; alkoxytitanium trihalides such as methoxytitanium trichloride, ethoxytitanium trichloride, butoxytitanium trichloride, phenoxytitanium trichloride and ethoxytitanium tribromide; and dialkoxytitanium dihalides such as dimethoxytitanium dichloride, diethoxytitanium dichloride, dibutoxytitanium dichloride, diphenoxytitanium dichloride and diethoxytitanium dibromide; and zirconium compounds and hafnium compounds corresponding to the above compounds, respectively. Among them, most preferred is titanium tetrachloride.

The halogen compounds of the group 13 of the periodic table, or the halogen compounds (b2) of the group 14 thereof are preferably those represented by the formula, M²R¹_{m-c}X⁸_{c}, wherein M² is an atom of the group 13 or 14; R¹ is a hydrocarbyl group having 1 to 20 carbon atoms; X⁸ is halogen atom; m is the valence of M²; and c is a number satisfying 0≦c≦m.

Examples of the atom of the group 13 are a boron atom, an aluminum atom, a gallium atom, an indium atom and a thallium atom. Among them, preferred is a boron atom or an aluminum atom, and more preferred is an aluminum atom. Examples of the atom of the group 14 are a carbon atom, a silicon atom, a germanium atom, a tin atom and a lead atom. Among them, preferred is a silicon atom, a germanium atom or a tin atom, and more preferred is a silicon atom or a tin atom.

The halogenation compound (b) is particularly preferably titanium tetrachloride, methyldichloroaluminum, ethyldichloroaluminum, tetrachlorosilane, phenyltrichlorosilane, methyltrichlorosilane, ethyltrichlorosilane, n-propyltrichlorosilane or tetrachlorotin, from a viewpoint of polymerization activity.

The above halogenation compounds (b1) and (b2) are preferably used at the same time or sequentially. Nonuse of the halogenation compound (b2) may not satisfy the requirements (2), (5), (6), (7) and (8), and the halogenation compound (b1) is preferably used from a viewpoint of polymerization activity.

(c) Phthalic Acid Derivative

Specific and preferable examples of the phthalic acid derivative (c) are those exemplified above as the phthalic acid derivative.

The solid catalyst component is obtained by contacting the solid component (a), the halogenation compound (b) and the phthalic acid derivative (c) one another, the solid component (a) being obtained by reducing the titanium compound (ii) represented by the formula [I] with the organomagnesium compound (iii) in the presence of the organosilicon compound (i) containing a Si—O bond. All of these contact treatments are usually carried out under an inert gas atmosphere such as nitrogen gas and argon gas.

A specific method of the contact treatment for obtaining the solid catalyst component (A) comprises preferably the steps of adding (b2) and (c) in any order to (a), thereby contacting them with one another, and then adding thereto a mixture of (b1) and (c), thereby contacting them with one another, wherein polymerization activity may be improved by further repeating the contact treatment with (b1) more than once.

The phthalic acid derivative (c) can be controlled optionally in its used amount such that the solid catalyst component (A) contains a suitable amount of a phthalic ester. The amount is usually 0.1 to 100 mmol, preferably 0.3 to 50 mmol, and further preferably 0.5 to 20 mmol, per 1 g of the solid component (a). Also, the phthalic acid derivative (c) is used in an amount of usually 0.01 to 1.0 mol, and preferably 0.03 to 0.5 mol, per 1 mol of a magnesium atom contained in the solid component (a).

The halogenation compound (b) is used in an amount of usually 0.5 to 1,000 mmol, preferably 1 to 200 mmol, and further preferably 2 to 100 mmol, per 1 g of the solid component (a).

Polymerization catalysts used for a production process of the ethylene-propylene copolymer of the present invention are obtained by contacting the solid catalyst component with an organoaluminum compound, wherein electron donors can be added optionally to contact with them.

The organoaluminum compound is a compound having one or more aluminum-carbon bonds in its molecule, and is preferably trialkylaluminums, mixtures of trialkylaluminums with dialkylaluminum halides, or alkylalumoxanes, and particularly preferably triethylaluminum, triisobutylaluminum, a mixture of triethylaluminum with diethylaluminum chloride, or tetraethyldialumoxane.

Examples of the electron donor are oxygen-containing compounds, nitrogen-containing compounds, phosphorus-containing compounds, and sulfur-containing compounds. Among them, preferred are oxygen-containing compounds or nitrogen-containing compounds.

Examples of the oxygen-containing compounds are alkoxysilicons, ethers, esters and ketones. Among them, preferred are alkoxysilicons or ethers, and particularly preferred is cyclohexylmethyldimethoxysilane, cyclohexylethyldimethoxysilane, diisopropyldimethoxysilane, tert-butylethyldimethoxysilane, tert-butyl-n-propyldimethoxysilane, phenyldimethoxysilane, diphenyldimethoxysilane, dicyclobutyldimethoxysilane, dicyclopentyldimethoxysilane, 1,3-dioxolane, 1,3-dioxane, 2,6-dimethylpiperidine, or 2,2,6,6-tetramethylpiperidine.

Although ethylene and/or propylene can be polymerized in the presence of the above catalyst, such a polymerization (real polymerization) may follow a pre-polymerization mentioned below.

The pre-polymerization is usually carried out by feeding a small amount of ethylene and/or propylene in the presence of the solid catalyst component (A) and an organoaluminum compound (B), and is preferably carried out in a slurry state. Examples of a solvent for the slurry are inert hydrocarbons such as propane, butane, isobutane, pentane, isopentane, hexane, heptane, octane, cyclohexne, benzene and toluene. When making the slurry, a part of the inert hydrocarbon solvent or the total thereof can be replaced by a liquid ethylene and/or propylene.

The organoaluminum compound is used in the real polymerization in an amount of 10 to 300 mol, preferably 100 to 300 mol, and more preferably 100 to 150 mol, per 1 mol of a titanium atom contained in the solid catalyst component (A). When the amount is larger than 300 mol, the requirement (3) may not be satisfied, and when the amount is smaller than 10 mol, it is not preferable from a viewpoint of polymerization activity.

Examples of a polymerization method known in the art are a solvent polymerization method, a slurry polymerization method and a gas phase polymerization method, which may be a continuous polymerization method or a batch-wise polymerization method.

Examples of solvents used for the solvent polymerization method or the slurry polymerization are aliphatic hydrocarbons such as butane, pentane, hexane, heptane and octane; aromatic hydrocarbons such as benzene and toluene; and halogenated hydrocarbons such as methylene dichloride.

The polymerization is carried out preferably at usually 20 to 100° C. and particularly preferably 40 to 90° C., under a pressure of an ordinary pressure to 6 MPa. A polymerization time is generally determined suitably according to a kind of a target polymer and a polymerization reaction apparatus, and is usually 1 minute to 20 hours. A ratio by weight of ethylene to propylene is 30/70 to 70/30.

Also, in order to regulate a molecular weight of the ethylene-propylene copolymer of the present invention, a chain transfer agent such as hydrogen may be added.

According to the above, the requirement (1) in the present invention can be accomplished by polymerizing ethylene with propylene in their ratio by weight of 30/70 to 70/30; the requirements (2), (4), (5), (6), (7) and (8) can be accomplished using the above solid catalyst component; and further the requirement (3) can be also accomplished by polymerizing using the above amount of the organoaluminum compound.

The polypropylene resin composition of the present invention comprises 55 to 95% by weight of the above polypropylene and 5 to 45% by weight of the above ethylene-propylene copolymer, the total of the polypropylene and the ethylene-propylene copolymer being 100% by weight.

When the above polypropylene content is more than 95% by weight, namely, when the above ethylene-propylene copolymer content is less than 5% by weight, impact strength may be insufficient, and when the above polypropylene content is less than 55% by weight, namely, when the above ethylene-propylene copolymer content is more than 45% by weight, stiffness may be insufficient.

The above polypropylene content is preferably 65 to 85% by weight, and thee above ethylene-propylene copolymer content is preferably 15 to 35% by weight.

The polypropylene resin composition of the present invention may contain inorganic fillers, in an amount of preferably 5 to 20% by weight, the total of the polypropylene resin composition being 100% by weight.

Also, the polypropylene composition of the present invention may contain additives such as heat stabilizers, nucleating agents (for example, aluminum salts of aromatic carboxylic acids, aromatic phosphate ester salts, and dibenzylidene sorbitol), ultraviolet absorbers, lubricants, antistatic agents, flame retardants, pigments, dyes, antioxidants (for example, phenol-based, sulfur-based and phosphorus-based antioxidants), dispersing agents, copper inhibitors, neutralizing agents, blowing agents, plasticizers, bubble inhibitors, cross-linking agents, flow improvers (for example, peroxides), light stabilizers, and weld-strength improvers.

Further, the polypropylene composition of the present invention may contain other polymers such as polyethylene and a propylene-ethylene random copolymer, which are different from the polypropylene and the ethylene-propylene copolymer used in the present invention.

The polypropylene composition of the present invention may contain the above additives or other polymers in an amount of usually 0.0001 to 10 parts by weight, per 100 parts by weight of the polypropylene composition of the present invention.

Examples of a method for producing the polypropylene resin composition of the present invention are as follows:

(1) a method comprising the step of melt-kneading all together the above polypropylene, the above ethylene-propylene copolymer, and optional components;

(2) a method comprising the steps of putting sequentially the above polypropylene, the above ethylene-propylene copolymer, and optional components into a mixing apparatus, and then melt-kneading them; and

(3) a method comprising the steps of polymerizing the above polypropylene, then polymerizing successively the above ethylene-propylene copolymer, thereby obtaining a polymer, and then melt-kneading the polymer and optional components.

Examples of the mixing apparatus are a Henschel mixer, a V-type blender, a tumble blender and a ribbon blender. Examples of the melt kneader are a single screw extruder, a multiple screw extruder, a kneader and a Banbury mixer.

The melt kneader is preferably a multiple screw extruder, a kneader or a Banbury mixer, from a viewpoint of excellent kneadability, thereby obtaining a polypropylene composition containing respective components dispersed highly homogeneously.

When a viscosity difference (melt flow difference) is large between the polypropylene and the ethylene-propylene copolymer, the polypropylene resin composition of the present invention is preferably produced according to a method, from a viewpoint of impact resistance of the obtained composition, comprising the steps of melt-kneading a polypropylene resin composition containing the polypropylene and the ethylene-propylene copolymer, which composition contains the ethylene-propylene copolymer in a larger amount than a pre-determined amount, and then adding the polypropylene to the obtained composition so as to adjust an amount of the ethylene-propylene copolymer to the pre-determined amount, thereby dilution-kneading them.

Examples of the above stepwise kneading method are as follows:

(1) a method comprising the steps of producing a first kneading product with a batch-wise kneader, recovering the first kneading product, further adding the polypropylene, and kneading again; and

(2) a method comprising the steps of producing a first kneading product with a continuous kneader such as an extruder, further adding the polypropylene from an intermediate position of the continuous kneader, and kneading.

Regarding a ratio of the polypropylene to the ethylene-propylene copolymer in the above stepwise kneading method, the first kneading product contains the ethylene-propylene copolymer preferably in a more amount than that of the polypropylene, more preferably in a ratio of 0.1 to 0.7; and further preferably in a ratio of 0.25 to 0.55.

The above method (3), which comprises the steps of polymerizing the polypropylene, and then polymerizing successively the ethylene-propylene copolymer (B), can be carried out, for example, according to a polymerization method known in the art using the above Ti—Mg solid catalyst known in the art and an organoaluminum compound.

The polypropylene resin composition of the present invention can be used for various materials such as automobile materials and home electric materials. As those various automobile materials or home electric materials, more preferred is the polypropylene resin composition containing the above fillers.

### EXAMPLES

The present invention is explained with the following Examples and Comparative Examples.

Various structural values of the ethylene-propylene copolymer in Production Examples 1 to 4 were measured according to the following methods.

(1) Propylene Content (Unit: % by mol)

It was measured under the following conditions according to a ¹³C-NMR spectrum method based on descriptions in M. De Pooter et al., Journal of Applied Polymer Science, 42, pages 399-408, U.S.A., 1991:
apparatus: JNM-EX 270 manufactured by JEOL LTD;
probe diameter: 10 mmφ;
solvent: o-dichlorobenzene;
temperature: 135° C.;
sample concentration: 5% by weight;
pulse width: 45;
repetition time: 10 seconds; and
cumulated number: 2500.

(2) Monomer Reactivity Ratio (r1r2)

It was obtained by measuring under similar conditions to those in the above (1), and calculated based on descriptions disclosed in Kakugo, et al., Macromolecules, 15, 1150 (1982).

(3) Intrinsic Viscosity ([η], Unit: dl/g)

It was measured at 135° C. with an Ubbellohde viscometer using a solution of a polymer in TETRALINE.

(4) Chain Length Distribution (Aw/An)

It was measured according to gel permeation chromatography (GPC) under the following conditions, wherein a calibration curve was prepared using standard polystyrenes, and a molecular weight distribution was estimated by the ratio of a weight-average molecular chain length (Aw) to a number-average molecular chain length (An), Aw/An:
apparatus: type 150C manufactured by Waters Corporation;
column: TSK-GEL GMH6-HT, 7.5 φmm×300 mm×3 columns;
measurement temperature: 140° C.;
solvent: o-dichlorobenzene; and
measurement concentration: 5 mg/5 mL.

(5) Glass Transition Temperature (Tg, Unit: ° C.)

It was measured with a differential scanning calorimeter DSC Q100 manufactured by TA Instruments according to a method comprising the steps of:
melting about 10 mg of a sample at 200° C. under a nitrogen atmosphere;
keeping at 200° C. for 5 minutes;
cooling down to −90° C. at a rate of 10° C./minute; and
heating up to 200° C. at a rate of 10° C./minute, thereby obtaining an endothermic curve, from which Tg was measured.

(6) Calorific Value of Crystallization (Unit: J/g)

It was measured using a similar apparatus to that in the above (5) according to a method comprising the steps of:
melting about 10 mg of a sample at 200° C. under a nitrogen atmosphere;
keeping at 200° C. for 5 minutes; and
cooling down to −90° C. at a rate of 10° C./minute, thereby obtaining an exothermic peak, from which the calorific value of crystallization per 1 gram (ΔHc) was obtained.

(7) Intensity Ratio of Racemic Peak to Meso Peak in Ethylene-Propylene Binding Moiety Contained in Propylene-Ethylene Copolymer Component

It was obtained by calculating am intensity ratio of the total peak (racemic-peak) of two peaks observed at about 38.4 ppm and about 38.8 ppm, to the total peak (meso-peak) of two peaks observed at about 37.5 ppm and about 37.9 ppm, those peaks being contained in a 13C-NMR spectrum measured according to a similar method to that in the above (1).

(8) Measurement of Eluted Resin in Temperature Rising Elution Fractionation Method
apparatus: CFC type T150A manufactured by Mitsubishi Chemical Co., Ltd.;
detector: Magna-IR550 manufactured by Nicolet-Japan Corp.;
wave length: data in a range of 2982 to 2842 cm⁻¹;
column: 2 columns of UT-806M manufactured by Showa Denko K.K.;
solvent: o-dichlorobenzene;
flow rate: 60 mL/hour;
sample concentration: 100 mg/25 mL;
sample injection volume of: 0.8 mL: and
support condition: cooling down to 0° C. from 140° C. at a rate of 1° C./minutes, leaving to stand for 30 minutes, and starting elution from a fraction at 0° C.

Physical properties of the propylene resin composition of the present invention were measured, as follows:

(9) Impact Strength (Unit: KJ/m²)

It was measured according to a method comprising the steps of:
heating about 40 g of the polypropylene resin composition at 200° C. for 5 minutes under no load using a hot press machine;
further heating at 200° C. for 2 minutes under a load of 15 MPa;
cooling for 3 minutes under a load of 15 MPa, thereby preparing a press sheet having a size of 150 mm×90 mm×3 mm;
cutting the sheet to make a test specimen having a size of 63 mm×8 mm×3 mm, notched by a machining process; and
measuring according to JIS K7110 at −30° C. and 23° C., respectively, with an Izod impact tester manufactured by Toyo Seiki Seisaku-sho, Ltd.

(10) Flexural Modulus (Unit: MPa)

It was measured at 23° C. using a test specimen (126 mm×8 mm×3 mm) prepared by the above method, with ABM-H/RTC-1310A manufactured by Orientec, according to JIS K7171 under conditions of a 48 mm-span and a 2.0 mm/minute-test speed.

(11) Melt Flow Rate (MFR, Unit: g/10 minutes)

It was measured at 230° C. under a load of 21 N according to JIS K7210.

### Preparation Example 1

(1) Synthesis of Solid Catalyst Component Precursor

A 200 L reactor equipped with a stirrer and a baffle plate was purged by nitrogen gas. There were put 80 L of hexane, 20.6 kg of tetraethoxysilane and 2.2 kg of tetrabutoxytitanium to the reactor, and the resultant mixture was stirred. Next, maintaining the reactor at 5° C., 50 L of a dibutyl ether solution (concentration: 2.1 mol/L) of butylmagnesium chloride was added drop-wise to the mixture over 4 hours. After completion of the drop-wise addition, the mixture was stirred at 5° C. for one hour, and further at 20° C. for one hour. The reaction mixture was filtered, and the obtained solid was washed three times with each 70 L of toluene. To the solid, 63 L of toluene was added, thereby obtaining a toluene slurry. A part of the slurry was sampled, and was subjected to solvent elimination and then drying, thereby obtaining a solid catalyst component precursor.

The solid catalyst component precursor was found to contain 1.86% by weight of Ti, 36.1% by weight of OEt (ethoxy group), and 3.0% by weight of OBu (butoxy group).

(2) Synthesis of Solid Catalyst Component

A 210 L-inner volume reactor equipped with a stirrer was purged by nitrogen gas. The slurry of the solid catalyst component precursor synthesized in the above (1) was fed to the reactor. There were put 14.4 kg of tetrachlorosilane and 9.5 kg of di(2-ethylhexyl)phthalate into the reactor, and the mixture was stirred at 105° C. for 2 hours. Next, the mixture was subjected to solid-liquid separation, then the obtained solid was washed at 95° C. three times with each 90 L of toluene, and then 63 L of toluene was added to the washed solid, thereby obtaining a toluene slurry. The obtained toluene slurry was heated up to 70° C., then 13.0 kg of TiCl4 was added thereto, and the mixture was stirred at 105° C. for 2 hours. Next, the mixture was subjected to solid-liquid separation. The obtained solid was washed at 95° C. six times with each 90 L of toluene, and was further washed at room temperature two times with each 90 L of hexane. The washed solid was dried, thereby obtaining 15.2 kg of a solid catalyst component.

The solid catalyst component was found to contain 0.93% by weight of Ti and 26.8% by weight of di(2-ethylhexyl)phthalate, and was found to have a specific surface area of 8.5 m²/g measured according to a BET method.

The above solid catalyst component precursor and solid catalyst component were analyzed as follows:
the titanium atom content was measured according to a method comprising the steps of decomposing about 20 mg of the solid sample with 47 mL of sulfuric acid having a concentration of 0.5 mol/L; adding thereto 3 mL of hydrogen peroxide water having a concentration of 3% by weight, thereby preparing a liquid sample; measuring a characteristic absorption of the liquid sample at 410 nm with a double-beam spectrophotometer, type U-2001, manufactured by Hitachi, Ltd.; and finding a titanium atom content with a calibration curve prepared in advance;
the alkoxy group content was measured according to a method comprising the steps of decomposing about 2 g of the solid sample with 100 mL of water to obtain a liquid sample; measuring an amount of an alcohol (corresponding to an alkoxy group) contained in the liquid sample according to a gas chromatography internal standard method; and converting the obtained amount of an alcohol to an alkoxy group content;
the content of the phthaic acid ester compound was measured according to a method comprising the steps of dissolving about 30 mg of the solid sample in 100 mL of N,N-dimethylacetamide, thereby preparing a solution; and measuring an amount of the phthaic acid ester compound in the solution according to a gas chromatography internal standard method; and
the specific surface area of the solid catalyst component was measured according to a BET method based on an absorption and desorption amount of nitrogen gas, using FlowSorb II 2300 manufactured by Micromeritics Instrument Corporation.

(3) Production of Ethylene-Propylene Copolymer

There was put 100 g of sodium chloride in an agitation type one liter stainless steel autoclave, and it was dried under reduced pressure. The autoclave was made the normal pressure with argon, and its inside was stabilized at 60° C. To the autoclave, 0.21 MPa of propylene, and a mixed gas of ethylene with propylene were added in this order, thereby obtaining the total pressure in the autoclave of 0.71 MPa, the mixed gas containing 40% by weight of ethylene. Next, a mixture containing 5 mL of pentane, 1.0 mmol of triethylaluminum and 31.0 mg of the solid catalyst component mentioned in Example 1(2) was pressed into the autoclave with argon, thereby initiating polymerization. The above ethylene-propylene mixed gas was fed to the autoclave at 65° C. under keeping a monomer partial pressure of 0.71 MPa, and the mixture was agitated for 3 hours. After completion of polymerization, the reaction mixture was taken out of the autoclave. Then, about 1 L of pure water was added to the mixture, and the resultant mixture was agitated for 1 hour. The mixture was subjected to filtration and vacuum drying, thereby obtaining 30 g of an ethylene-propylene copolymer. Structural values of the obtained ethylene-propylene copolymer are shown in Table 1.

### Preparation Example 2

Example 1(3) was repeated except that 47.3 mg of the solid catalyst component described in Preparation Example 1(2) was used, thereby obtaining 14 g of an ethylene-propylene copolymer. Structural values of the obtained ethylene-propylene copolymer are shown in Table 1.

### Preparation Example 3

[Production of Ethylene-Propylene Copolymer]

There was put 100 g of sodium chloride in an agitation type one liter stainless steel autoclave, and it was dried under reduced pressure. The autoclave was made the normal pressure with argon, and its inside was stabilized at 60° C. To the autoclave, 0.21 MPa of propylene, and a mixed gas of ethylene with propylene were added in this order, thereby obtaining the total pressure in the autoclave of 0.71 MPa, the mixed gas containing 40% by weight of ethylene. Next, a mixture containing 5 mL of pentane, 1.0 mmol of triethylaluminum, 0.1 mmol of n-propylmethyldimethoxysilane, and 7.78 mg of a Ti—Mg solid catalyst disclosed in JP 2003-105018A, Example 1 was pressed into the autoclave with argon, thereby initiating polymerization. The above ethylene-propylene mixed gas was fed to the autoclave at 65° C. under keeping a monomer partial pressure of 0.71 MPa, and the mixture was agitated for 42 minutes. After completion of polymerization, the reaction mixture was taken out of the autoclave. Then, about 1 L of pure water was added to the mixture, and the resultant mixture was agitated for 1 hour. The mixture was subjected to filtration and vacuum drying, thereby obtaining 16 g of an ethylene-propylene copolymer. Structural values of the obtained ethylene-propylene copolymer are shown in Table 1.

### Example 1

There were melt-kneaded 75 parts of polypropylene having a melting temperature (Tm) of 164° C. and an intrinsic viscosity ([η]) of 1.44 dl/g, 15 parts of the ethylene-propylene copolymer of Preparation Example 1, 0.05 part of calcium stearate manufactured by NOF Corporation, 0.1 part of SUMILIZER GA-80 manufactured by Sumitomo Chemical Co., Ltd. and 0.2 part of SUMILIZER GP manufactured by Sumitomo Chemical Co., Ltd., at 190° C. for 7 minutes at 80 rpm, using LABO PLASTOMILL manufacture by Toyo Seiki Seisaku-sho, Ltd., provided that each of the above amounts of calcium stearate, SUMILIZER GA-80 and SUMILIZER GP was based on 100 parts of the total of the above polypropylene and the above ethylene-propylene copolymer.

Next, there were kneaded 15 parts of the above-obtained kneaded product, 59 parts of polypropylene, 0.05 part of calcium stearate manufactured by NOF Corporation, 0.05 part of SUMILIZER GA-80 manufactured by Sumitomo Chemical Co., Ltd. and 0.05 part of ULTRANOX U626 manufactured by GE Specialty Chemicals Inc., at 190° C. for 5 minutes at 80 rpm, using LABO PLASTOMILL manufacture by Toyo Seiki Seisaku-sho, Ltd., provided that each of the above amounts of calcium stearate, SUMILIZER GA-80 and ULTRANOX U626 was based on 100 parts of the total of the polypropylene and the ethylene-propylene copolymer. The used ethylene/propylene component and measurement results of physical properties are shown in Table 2.

### Example 2

Example 1 was repeated, except that the ethylene-propylene copolymer of Preparation Example 1 was changed to the ethylene-propylene copolymer of Preparation Example 2. The used ethylene/propylene component and measurement results of physical properties are shown in Table 2.

### Comparative Example 1

Example 1 was repeated, except that the ethylene-propylene copolymer of Preparation Example 1 was changed to the ethylene-propylene copolymer of Preparation Example 3. The used ethylene/propylene component and measurement results of physical properties are shown in Table 2.

### Example 3

Example 1 was repeated, except that 54 parts of propylene and 20 parts of the ethylene-propylene copolymer of Preparation Example 1 were used, respectively. The used ethylene/propylene component and measurement results of physical properties are shown in Table 2.

### Comparative Example 2

Example 3 was repeated, except that the ethylene-propylene copolymer of Preparation Example 1 was changed to the ethylene-propylene copolymer of Preparation Example 3. The used ethylene/propylene component and measurement results of physical properties are shown in Table 2.

### INDUSTRIAL APPLICABILITY

According to the present invention, there can be obtained a polypropylene resin material excellent in its stiffness and impact resistance.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

TABLE 1

| | Preparation Example | | |
|---|---|---|---|
| | 1 | 2 | 3 |
| ¹³C-NMR | | | |
| Propylene content (% by mol) | 42.3 | 37.3 | 47.5 |
| r1r2 | 1.21 | 1.80 | 3.63 |
| Racemi-meso peak intensity ratio | 0.14 | 0.11 | 0.00 |
| [η] (dl/g) | 2.31 | 3.19 | 2.23 |
| GPC | | | |
| Aw/An | 10.3 | 11.8 | 6.2 |
| DSC | | | |
| Tg (° C.) | −53.2 | −52.4 | −45.8 |
| ΔHc (J/g) | <0.1 | 0.51 | 8.84 |
| Temperature rising elution fractionation | | | |
| method | | | |
| Elution proportion at lower than 10° C. | 85.1 | 66.3 | 65.4 |
| (% by weight) | | | |
| Elution proportion at 10° C. to lower than | 10.6 | 25.8 | 19.8 |
| 55° C. (% by weight) | | | |
| Elution proportion at 83° C. or higher | 1.2 | 3.9 | 4.5 |
| (% by weight) | | | |

TABLE 2

| | | | Comparative | |
|---|---|---|---|---|
| Example | | | Example | |
| 1 | 2 | 3 | 1 | 2 |

Ethylene-propylene
copolymer

| | | | | | | |
|---|---|---|---|---|---|---|
| Kind (Note) | | PE1 | PE2 | PE1 | PE3 | PE3 |
| Amount | % by | 15 | 15 | 20 | 15 | 20 |
| | weight | | | | | |
| MFR | dg/min | 9.9 | 10.5 | 8.7 | 9.8 | 8.9 |
| Flexural | MPa | 1,206 | 1,160 | 1,054 | 1,212 | 1.100 |
| modulus | | | | | | |
| Impact strength | | | | | | |
| 23° C. | kJ/m² | 8.0 | 7.0 | 13.2 | 5.4 | 6.0 |
| −30° C. | kJ/m² | 2.4 | 2.7 | 3.5 | 2.2 | 2.6 |

(Note): PE1, PE2 and PE3 mean “Preparation Example 1”, “Preparation Example 2” and “Preparation Example 3”, respectively.

We claim:

1. A process for producing an ethylene-propylene copolymer having following structural characteristics (1) to (8):
(1) its propylene content measured according to a ¹³C-NMR spectrum is 20 to 60% by mol;
(2) its product of a monomer reactivity ratio measured according to a ¹³C-NMR spectrum is less than 2.5;
(3) its intrinsic viscosity measured at 135° C. in TETRALINE is more than 1.0 dl/g;
(4) its molecular weight distribution measured according to gel permeation chromatography is more than 3;
(5) its glass transition temperature measured according to DSC is lower than −40° C.;
(6) its heat of crystallization in a temperature range of 40 to 110° C. measured according to DSC is less than 5.0 J/g;
(7) in a temperature rising elution fractionation method with a solvent of o-dichlorobenzene, its elution amount is 60% by weight or more in a temperature range of lower than 10° C., its elution amount is 3% by weight or more in a temperature range of 10° C. to lower than 55° C., and its elution amount is 5% by weight or less in a temperature range of 83° C. or higher, provided that the total elution amount is 100% by weight; and
(8) an intensity ratio of a racemic peak to a meso peak in an ethylene-propylene binding moiety measured according to a 13C-NMR spectrum is 0.01 to 0.7;
the process comprising steps of (i) contacting a solid component containing a magnesium atom, a titanium atom and a hydrocarbyloxy group, a halogenation compound and an ester compound with one another to produce a solid catalyst component, (ii) contacting the solid catalyst component with an organoaluminum compound to produce a polymerization catalyst, and (iii) polymerizing ethylene with propylene in the presence of the polymerization catalyst.

2. A process for producing a polypropylene resin comprising combining 5 to 45% by weight of the ethylene-propylene copolymer produced by the process of claims 1 and 55 to 95% by weight of polypropylene having a melting temperature of 160° C. or higher measured according to DSC, wherein the total of the polypropylene and the ethylene-propylene copolymer is 100% by weight.
